(19) United States
(12) Patent Application Publication
(10) Pub. No.: US 2007/0071394 A1
(43) Pub. Date: Mar. 29, 2007

(54) Low loss microring resonator device

(76) Inventors: Daniele Franco Angelo Faccio, Milano (IT); Marco Romagnoli, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/584,315

(22) PCT Filed: Dec. 24, 2003
(86) PCT No.: PCT/EP03/14918

§ 371 Date: Jun. 23, 2006

(51) Int. Cl. G02B 6/10

(52) U.S. Cl. 385/131; 385/130; 385/132

(57) ABSTRACT

A low loss micro-ring resonator device which has a closed-loop resonator waveguide having a first refractive index, the resonator waveguide defining an inner and an outer region by an outer curved edge of the waveguide. The resonator waveguide is arranged on a substrate having a second refractive index, the refractive index difference between the first refractive index and the second refractive index is greater than 0.3. The device also has an upper cladding covering the inner region of the resonator waveguide having a third refractive index and a lateral cladding in contact with the outer curved edge and extending in the outer region, the lateral cladding having a fourth refractive index, the fourth refractive index being lower than the third refractive index. A method for reducing propagation losses of a resonator device is also described.

### TECHNICAL FIELD

The present invention relates to a low loss micro-ring resonator device, in which propagation losses are minimized for a given resonator device configuration. Additionally, the invention is also relative to a method to reduce propagation losses in a resonator device.

### TECHNOLOGICAL BACKGROUND

Micro-resonators have shown considerable versatility over the last decade as candidates for wavelength filtering, routing, switching, modulation, dispersion compensators, laser and multiplexing/demultiplexing applications. Their size has progressively decreased and therefore they have attracted considerable attention for their potential use in integrated optical devices making all-optical signal processing a closer possibility.

A small resonator size is also extremely important in dense wavelength division multiplexed (DWDM) systems, which require optical filters characterized by high selectivity and large FSR (Free Spectral Range).

A resonator consists of a waveguide in a closed loop, such for example a ring, racetrack or ellipse. Power is coupled to the resonator by evanescent coupling from waveguides placed close to it, the amount of which depends on the coupling factor of the used coupler. These waveguides are called “bus waveguides” and are normally one or two, in this latter case called input and output waveguide. The resonator supports resonances at given wavelengths, which are determined by the geometrical details and the refractive index distribution of the resonator. At these special resonant wavelengths, which are given by

$${λ}_{R} = \frac{2 π {Rn}_{eff}}{m} ,$$

where m is an integer, n_{eff} the effective index of the waveguide resonator and R the ring radius (or, more generally, the optical path), optical power fed to the resonator from the input waveguide circulates in the resonator and builds up to large intensities, i.e. it sets up standing wave modes of low loss. Energy in the resonator at resonance may also couple to an output waveguide—if present—and it can be shown that all of the power present at the input can be transferred at the output waveguide. Light propagating in the input waveguide with a wavelength that is off resonance with the resonator is not coupled to the resonator but continues to propagate in the input waveguide. In this configuration with two waveguides, the resulting device is called optical channel dropping filter because the output waveguide is used to extract resonant frequencies. In case only a single (input) waveguide is present, the configuration is called “all-pass”, and acts as a phase filter.

The minimum size of a resonator is limited, among others, by the bending induced losses associated with the smallest radius of curvature. It is known that the bends become a great source of loss when the radius of curvature is less than a certain value. Light propagating at the inner side of the bend travels a shorter distance than that on the outer side. To maintain the phase of the light wave, the mode phase velocity of the outer-most portion—having the higher radius of curvature—of the mode must increase with respect to the inner most portion. When the waveguide bend is less than some critical radius, this outer-most mode portion phase velocity must increase to a speed equal to the velocity in the material outside the waveguide (i.e. it becomes equal to the outside radiation modes). This condition causes some of the light within the waveguide to be converted to high-order modes which are then lost or radiated out of the waveguide.

Bending losses increase the bandwidth B of the resonance peaks. Since a resonator device for DWDM applications has a limited radius, of the order of less than 10 microns, bending losses are extremely relevant.

In order to recover the optical confinement and reduce the bending losses, it has been proposed to increase the index contrast between the “lateral” cladding and the core of the resonator waveguide or to increase the resonator-core size. With the term “lateral” cladding, it is intended the cladding in-plane with the resonator, i.e. the cladding that contacts the surfaces of the resonators from which light radiates, which are substantially perpendicular to the substrate. Waveguides in which the index difference Δn between the core and the lateral cladding is equal to or larger than 0.3 are called high index difference waveguides or tightly confined waveguides and can be made in several different geometries.

On the other hand, arbitrary large index difference is not necessarily desiderable. In particular, as Δn increases, scattering losses also increases. Basically, scattering losses are caused by the interaction of light with side-wall roughness of the waveguide. Roughness is a random perturbation of the waveguide width and it is produced when waveguides, e.g., micro-rings, are manufactured, in particular the fabrication process has random fluctuations in the transverse direction. The roughness in the vertical direction (i.e. in the direction substantially perpendicular to the plane on which the resonator lies) is not important as the material deposition process usually results in very smooth surfaces.

A particularly desiderable additional characteristic of resonator devices, in particular when configured as wavelength-selective optical filters in add/drop devices, is wavelength tunability, so that their dropped wavelength may be changed, in order to increase the flexibility of networks. The goal of a tunable filter is therefore to select one channel (or several channels) in a given incoming input optical signal and transmitting all other channels through the filter, said channel being changeable. In the present case, it is preferable to tune the position of the resonant frequency of the resonator from one channel wavelength to any other in the relevant spectrum, e.g. across the erbium C-band, so that it would allow dropping any single channel with an extremely simple layout of only one filter. It is also important to note that the tuning mechanism is preferably required to be hitless, i.e. whilst tuning from one channel to another, none of the channels lying in between must be significantly affected.

Several different tunable optical filters have been developed. A proposed solution has been to realize the core region of the waveguide resonator in a tuneable material, i.e. a material whose refractive index may be changed, therefore changing n_{eff}. This implies, a change in the resonance wavelength λ_{R}.

U.S. Pat. No. 5,018,811 in the name of Nothrop Corporation describes a ring resonator in which bending losses are minimized through a waveguide fabrication process such that the ring waveguide has a greater index of refraction difference, relative to the material external to the waveguide, along the outer radius than along the inner radius. The refractive index of the ring varies across the waveguide itself, and this is achieved using ion exchange. Above the ring waveguide, over the inner region and over the outer region with respect to the ring, the cladding is air.

In both European patent application No. 365724 and U.S. Pat. No. 4,988,156, a waveguide having one or more bends is disclosed. To minimize bending losses, the cladding region around the bend is realized in a material having a refractive index greater than the cladding outside the bend region. Applicants have noted that this solution is feasible only for bends of few degrees and extremely localized, otherwise losses will be extremely important.

U.S. Pat. No. 6,621,972 in the name of the Massachusetts Institute of Technology is relative to a waveguide comprising a 90° bend. To minimize losses, air trench cladding are used in the bend region.

European patent application EP 1058136 in the name of British Telecommunications, teaches to reduce bending losses realising an empty groove on the outside of a bend and an empty groove on the inside of the bend. The refractive index within both grooves is substantially equal to one, i.e. both contain air.

In the International Patent Application WO 02/25338 in the name of the Massachusetts Institute of Technology, a tunable micro-resonator is disclosed having a core and cladding, in particular the tuning is realised by variation of the cladding refractive index. This is obtained by electro-optic effect, acusto-optic effect, by MEMs and by thermo-optic effect. An electro-optic material is deposited on top of the core as a cladding layer whose refractive index can be changed. The change in index can be exploited as a tuning mechanism.

Applicants have noted that depositing the tunable cladding only over the ring core can be technologically demanding due to the limited core dimensions and that the bending losses are only partially reduced.

In the slides entitled “Guided-Wave Optical Microresonators: calculation of Eigenmodes”, presented at the International School of Quantum Electronics, 39th Course, in Erice, Italy, 18-25 Oct. 2003, and published on the web site http://w3.uniroma1.it/cattedra michelotti/slides.htm, a ring microresonator is described, which comprises a polymer ring core, having refractive index n_{c}=1.5965, and a polymer upper cladding n_{cl}=1.4468 covering the inner region defined by the ring inner radius and the ring core itself. In the outer ring region the cladding is air. The polymer cladding is deposited to reduce bending losses. The buffer on which the ring lies is realized in the same material as the upper cladding.

Applicants have pointed out that the refractive index difference between the core and the buffer is very low and it is not suitable for fabrication of small rings, i.e. rings having radius of the order of few μm, which are of interest for DWDM applications. It is also worth noting that a buffer and upper cladding having the same refractive index is not the optimal configuration for bending losses reduction. Additionally, in case a tunable micro-ring is desired, Applicants have noted that employment of polymeric materials in the waveguide core region—as in the article's examples—makes polymer stability a crucial issue and may affect long-term reliability of the resonator which acts as a filter. In any case, the polymers disclosed in the article are not suitable for tuning.

In “Experimental and Numerical Study of SiON Microresonators with Air and Polymer Cladding” published in Journal of Lightwave Technology, Vol. 21, No. 4, pages 1099-1110, a microresonator having a Si₃N₄ core having a SiO₂ buffer layer and an upper cladding in polymethylmethacrylate covering the whole device (inner and outer region with respect to the ring) is disclosed. In this article, the effect of the cladding refractive index variations is studied and it is shown that the bending losses decrease toward a minimum and then increase rapidly for claddings having refractive indices larger than the buffer layer.

Applicants have noted that a very small losses reduction is achieved for a limited refractive index range of the cladding covering all the resonator device. On the contrary, losses are sharply increased when the cladding refractive index is increased outside this limited range.

### SUMMARY OF THE INVENTION

The present invention relates to a low loss micro-ring resonator device, and to a method to reduce the propagation losses of a resonator device, preferably for DWDM applications, configured so that its propagation losses are minimized.

In the following only resonator devices comprising at least a resonator having a closed-loop shape and a bus waveguide are considered, the term “ring” being used to indicate more generally any closed-loop geometry. An example of a possible geometry is given in FIGS. 1a and 6, where the resonator is considered to lie on a (X,Y) plane, in particular on a planar substrate. Bus waveguides coupling to the resonator may lie on the same plane or on others. In a top plane view of the resonator device, the resonator is bound by two curves (in case of a ring, by two circumferences) which are called external and internal curve.

One of the main objects of the resonator device of the invention is to reduce the total losses while obtaining at the same time a relatively high finesse, for example of 30-40.

Applicants have found that covering the resonator with a layer of a first material that extends to the outer edge of the resonator can lower the propagation losses in the resonator. The layer covering the resonator, referred in the following to as the upper cladding has a refractive index higher than the refractive index of the material surrounding it in the “lateral” direction, i.e., the material which is in contact with the resonator surface delimited by the external edge, and which forms what hereafter will be referred to as the lateral cladding.

More specifically, the upper cladding covers the portion of the upper surface of the resonator substantially opposite to the substrate and parallel to the (X,Y) plane defined by the substrate, and covers also the portion of the substrate delimited by the internal edge defined by the resonator, so that also a inner lateral surface of the resonator, delimited by the inner edge, is in contact with the upper cladding. The outer lateral surface, extending substantially along the Z-direction perpendicular to the (X,Y) plane, is in contact with the lateral cladding, which surrounds the resonator and contact in turn the upper cladding. The lateral cladding extends in the radial direction from the outer lateral surface of the resonator for a given extent.

Surprisingly, Applicants have realized that increasing the refractive index of the upper cladding while keeping fixed the refractive indices of the other materials, steadily decreases the losses of the device. Decrease occurs up to a maximum value of the upper cladding refractive index, the value depending on the given resonator configuration.

In order to obtain this good loss reduction, also a high refractive index difference between the refractive indices of the materials in which the resonator and the substrate are realized, in particular greater than 0.3, should be present.

The resonator device of the invention is preferably tunable. Applicants have found that a wide-range tunability can be obtained by using as the upper cladding a tunable material, i.e. a material whose refractive index can be varied with variation of an external parameter, such as temperature or electric field.

Applicants have realized that the losses reduction due to the upper cladding refractive index increase is due to a better lateral confinement, i.e. in the (X,Y) plane, of the mode. Concurrently with an improvement of the lateral confinement, the mode propagating in the resonator has a more pronounced spatial overlap into the upper cladding, i.e., along the Z direction.

Applicants have found that a significant spatial overlap of the propagation mode into the upper cladding makes possible that a variation in the refractive index of the upper cladding will induce a significant variation of the n_{eff} in the waveguide. Therefore, if the upper cladding has a refractive index that is selectively variable over a relatively wide range of values, efficient tunability can be achieved.

Preferably, at least one of the dimensions of the cross-section of the ring resonator should be of the order of

$$\frac{λ}{{n}_{eff}} ,$$

which is the order of magnitude of the mode extension in the n_{eff} resonator, where n_{eff} is the effective index of the resonator waveguide and λ the wavelength of the propagating mode.

Therefore, if all dimensions of the cross-section of the resonator were higher than

$$\frac{λ}{{n}_{eff}} ,$$

this effect would be limited because the mode would penetrate in the upper cladding for a negligible amount.

Preferred materials for the upper cladding are polymers, the refractive index of which varies with temperature, and liquid crystals, the refractive index of which varies with electric field.

According to the method of the invention, in order to reduce losses of a resonator device which may be realized according to any standard technique and well-known materials, as the latest step of the fabrication, the upper cladding, having a refractive index greater than the refractive index of the lateral cladding, is deposited over the resonator and then patterned.

In a further embodiment of the invention, a lateral cladding may also be deposited, in particular as confinement layer if the material in which the upper cladding is made is a liquid crystal.

These objects and others, which will become clear from the following description, are achieved by the invention with a low loss micro-ring resonator device and a method to reduce propagation losses in a resonator device obtained in accordance with the appended claims.

### BRIEF DESCRIPTION OF THE DRAWINGS

Further features and advantages of a low loss micro-ring resonator device according to the invention and of the method to reduce propagation losses in a resonator device will become more clearly apparent from the following detailed description thereof, given with reference to the accompanying drawings, where:

FIG. 1a is a schematic top plan view of a first embodiment of a low loss micro-ring resonator device according to the invention;

FIG. 1b is a schematic top plan view of a second embodiment of a low loss micro-ring resonator device according to the invention;

FIG. 1c is a graph showing the wavelength response of the resonator device of FIG. 1a as a function of the input wavelength;

FIG. 2 is a schematic cross sectional view of an additional resonator device;

FIG. 3 is a graph showing the bending losses as a function of the radius of the resonator device of FIG. 2 in which the upper cladding is air;

FIG. 4 is a graph showing the scattering losses as a function of the refractive index difference between core and cladding of the resonator device of FIG. 2 in which the upper cladding is air;

FIG. 5 is a graph showing the total loss, scattering losses and bending losses as a function of the radius of the resonator device of FIG. 2 in which the upper cladding is air;

FIG. 6 is a schematic cross-sectional view of the resonator device of FIG. 1a;

FIG. 7a-7d are cross-sectional views of contour plots of the numerical calculated fundamental mode for different upper cladding indices in the resonator device of FIG. 1a;

FIG. 8 is a graph showing the total loss for a round trip in the resonator device of FIG. 6 as a function of the refractive index of the upper cladding of the resonator device of FIG. 1a and for different resonator radii;

FIG. 9 is a graph showing the total loss for a round trip in the resonator device of FIG. 1a as a function of the refractive index of the upper cladding of the resonator device of FIG. 1a and for different core cross-sections of the resonator;

FIG. 10a is a schematic cross-sectional view of an additional realization of the resonator device of FIG. 1a;

FIG. 10b is a schematic top plan view of the resonator device of FIG. 10a;

FIG. 11 is a schematic cross-sectional view of a third embodiment of a low loss micro-ring resonator device according to the invention;

FIG. 12 is a graph showing the total loss for a round trip in the resonator device of FIGS. 10a and 10b as a function of the refractive index of the upper cladding of the resonator device and for different resonator radii;

FIG. 13 is a graph analogous to the graph of FIG. 3 showing additionally the bending losses of the resonator device of FIG. 1a;

FIG. 14 is a graph analogous to the graph of FIG. 4 showing additionally the scattering losses of the resonator device of FIG. 1a;

FIG. 15 is a schematic graph showing in gray the region of preferable upper cladding refractive indices as a function of the refractive index of the core of the resonator device of FIG. 1a;

FIG. 16 shows a schematic view of a filter architecture comprising Mach-Zehnder switches and one or more of the resonator devices of FIGS. 1a and/or 10a-10b and/or 11.

### PREFERRED EMBODIMENTS OF THE INVENTION

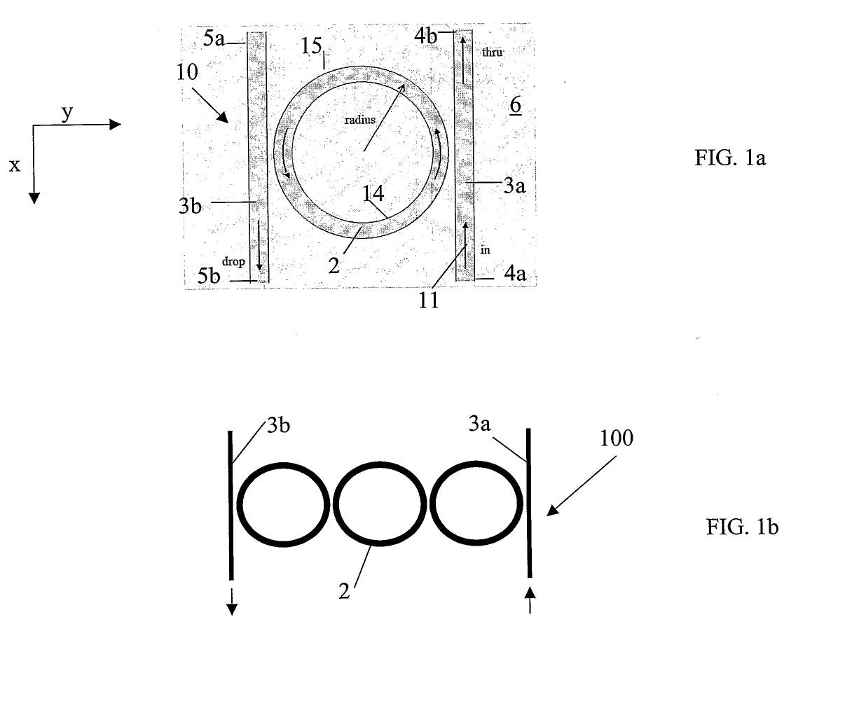

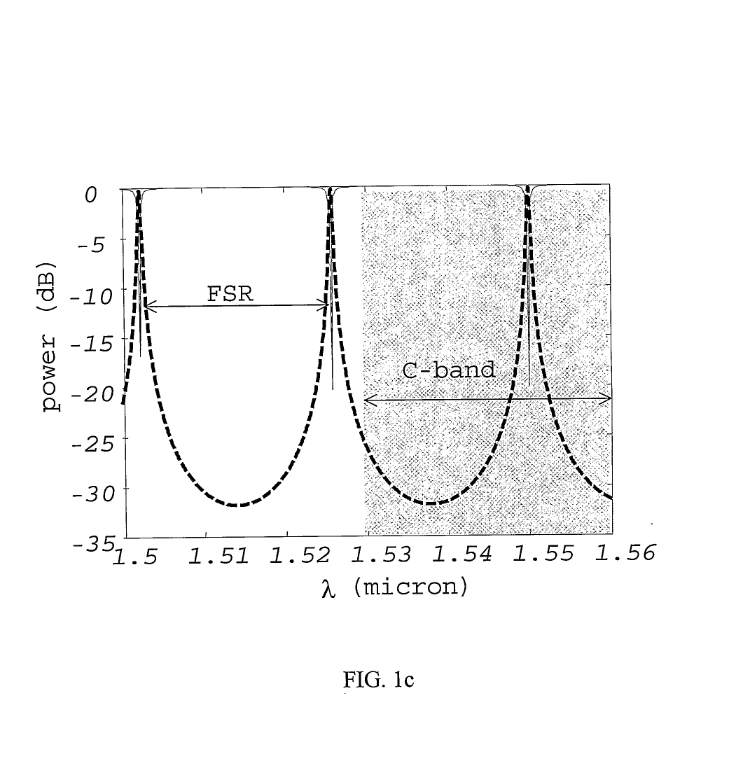

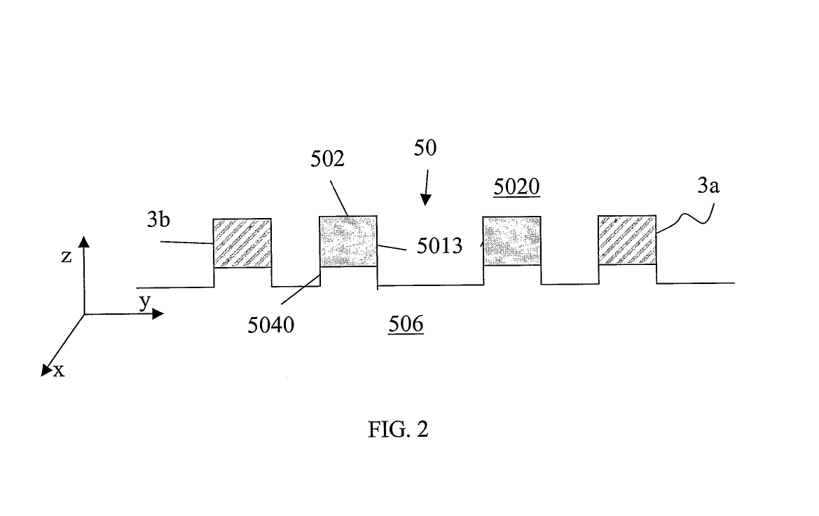

With initial reference to FIG. 2, a sectional view of a resonator device 50, the plan view of which is given in FIG. 1a, is examined.

This device 50 comprises a ring-shaped resonator 502 which is made of Si-rich Si₃N₄ (nᵣ=2.2) having rectangular cross-section of 1200×250 nm² with an over-etch 5040 of 200 nm, the substrate 506 is SiO₂, and an air cladding 5020 (refractive index nₐᵢᵣ=1) extending over the all area of the device.

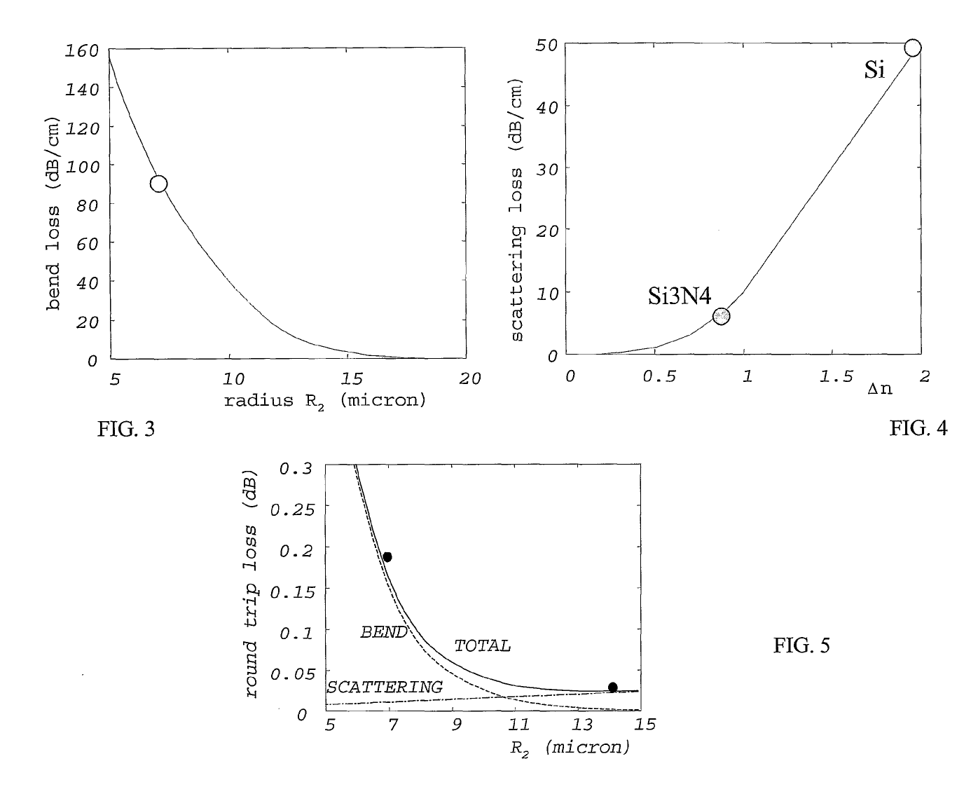

In FIGS. 3 and 4 the bending and scattering losses, respectively, of the resonator device 50 are shown. In particular, the circle represented in FIG. 3 indicates the bending losses of resonator device 50 having radius of 7 μm and the curve gives the bending loss as a function of the radius R₂. In FIG. 4 the scattering losses as a function of the refractive index difference between the resonator waveguide 502 refractive index and the refractive index of the cladding is shown: simulations were carried out by the Applicants for a generic configuration having a core surrounded by a cladding having a refractive index difference Δn with the core. The two circles represent the values of the scattering losses for a core made of Si-rich Si₃N₄ or of Si, both with a SiO₂ substrate and air cladding.

Therefore, it is clear from the FIGS. 3 and 4 that the bending losses depends on the resonator radius, but also on the refractive index difference between the resonator waveguide 502 refractive index and the refractive index of the cladding: the higher is this difference, the lower are the bending losses due to a higher confinement of the propagating mode inside the resonator waveguide. However, as clearly seen from FIG. 4, increasing the refractive index difference causes an increase of the scattering losses.

A summary of these results is given in FIG. 5 where the total loss of the device 50 as a function of the radius of the resonator 502 is shown. Resonator 502 is a ring made of Si-rich Si₃N₄ (nᵣ=2.2) having 100 nm of over etch, rectangular cross-section of 1000×330 nm, air upper cladding 520 and SiO₂ substrate 506. The lines are numerical simulations of the above described device, while the two circles are experimental results.

Therefore, in order to realize ring resonators in integrated optics and in DWDM systems which requires strong confinement to achieve low bending radii, it is extremely important to minimize the total loss in the waveguide, in particular bending and scattering losses. This allows to obtain high finesse resonator filters.

With reference now to FIG. 1a, 10 indicates a low loss micro-ring resonator device according to the present invention.

The resonator device 10 comprises a resonator, in particular a resonator waveguide 2 having refractive index nᵣ, and at least a bus waveguide 3a in close proximity to the resonator waveguide 2 and having a refractive index n_{w}. The resonator waveguide 2 and bus waveguide 3a are preferably single mode waveguides. In particular, in the application of FIG. 1a, the device 10 also comprises a second bus waveguide 3b, the first and second waveguide 3a, 3b having an input port 4a and an output port 4b, and an add port 5a and a drop port 5b, respectively. The resonator waveguide 2 is realized on a substrate 6, preferably a planar layer of refractive index n_{b}, defining a (X,Y) plane.

In the following, one of the possible applications of the device of the present invention will be exemplified, in particular the preferred embodiments described afterwards are relative to the use of the low loss micro-ring resonator device 10 as an optical filter. However the resonator device of the invention can be used as a building block for other applications, such as higher order ring resonator filters, to achieve, for example, flat-top passbands. An example of such filter is schematically depicted in FIG. 1b in which a configuration of a filter device 100 including three micro-ring resonator waveguides 2 is shown. The device of the present invention is not limited in the number of resonators used, which may vary depending on the desired application.

A non-limiting list of possible additional applications which could be realized with the resonator device 10 of the present invention is the following: it can be used in a multistage dispersion compensator; if integrated with a photo-diode it may be used to stabilize a laser diode emitting at a specific wavelength or for definite switching in FSR channel spacing; it can be integrated in high performance add/drop filters or in Mach-Zehnder interferometers for use, for example, as a compact notch filter; it is a candidate to be used in optical division multiplexed transmission and in polarization division multiplexing systems.

The resonator waveguide 2 is a closed-loop waveguide. It can have for example, in top plan view, the shape of a circular ring, as in FIG. 1a, of an elliptical ring or of a racetrack. In the following, therefore, the term “ring” will be broadly used for any closed-loop geometry.

A typical spectral response of the device of FIG. 1a is shown schematically in FIG. 1c, in which peaks are observed at the resonance wavelengths of the resonator 2. The distance between resonance peaks is called the free spectral range (FSR) of the resonator 2 and this is dependent, among others, on the size of the resonator (i.e. in case of a circular ring resonator, on its radius). Preferably, in order to filter channels whose wavelengths are comprised in the C-band which has a width of more than 40 nm, the FSR of the resonator device 10 of the invention should be higher than 20 nm. Therefore, the radius of the resonator 2 is preferably comprised between 5 and 10 μm, more preferably between 5 and 8 μm, still more preferably of 6 μm. In case of a non-circular loop of the resonator waveguide 2, with the term “radius” half of the maximum extension in the (X,Y) plane of the resonator waveguide 2 is intended.

The bandwidth B of a resonance peak depends only, having fixed the other resonator characteristics, on the couplings κ between the resonator 2 and the bus waveguides 3a, 3b if losses are negligible; otherwise losses increase the bandwidth B. A small bandwidth is preferred in DWDM applications where high selectivity is very important in order not to modify the channels which are not filtered. Therefore, defining the finesse F of the resonator 2 as the ratio

$$F = \frac{FSR}{B} ,$$

the resonator device 10 has preferably a high finesse which is obtained as explained in the following.

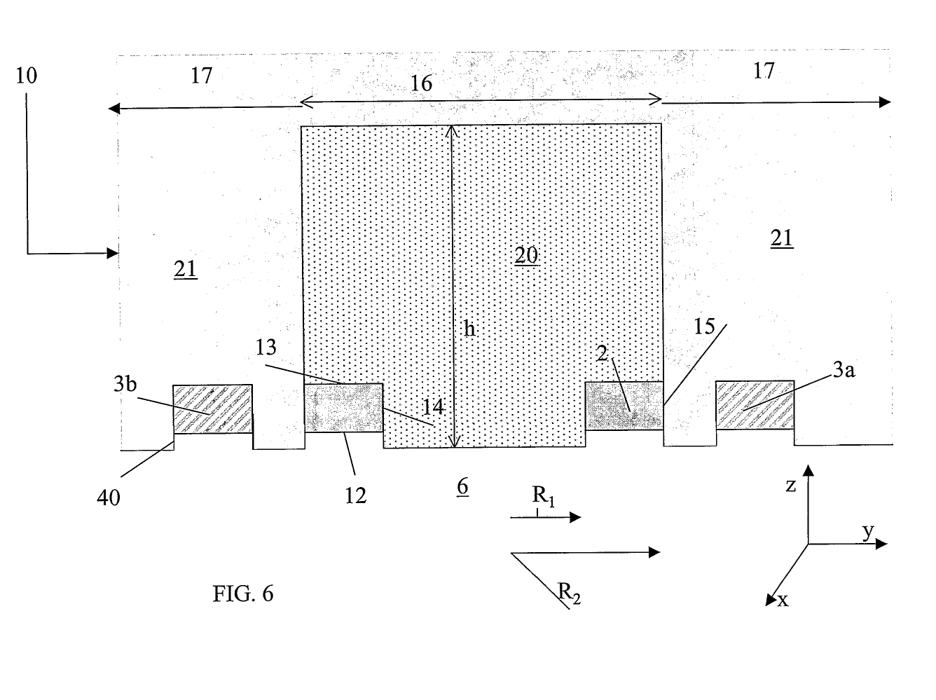

FIG. 6 schematically illustrates a cross-section of the resonator device according to an embodiment of the present invention. The same reference numerals are given to elements of the resonator device corresponding to those shown in FIG. 1a and their detailed explanation is omitted.

A first portion 12 of the surface defining the boundary of the resonator waveguide 2 is in contact with the substrate 6 and the remaining second portion 13 with a cladding which will be better defined below.

Due to the closed-loop shape of the ring resonator waveguide 2, two distinct regions are identified: an inner region 16 and an outer region 17. Calling inner curved edge 14 the curved edge delimiting the inner boundary of the ring and outer curved edge 15 the curved edge delimiting the outer boundary of the ring, the inner region 16 is the region which covers the inner part of the substrate inside the ring and the upper part of the resonator waveguide 2 up to the outer curved edge 15, and the outer region 17 is the region which covers the substrate extending from the outer curved edge 15 outside the inner region 16. In the example of FIG. 1a in which the resonator 2 is a ring having inner radius R₁ and outer radius R₂ (see FIG. 6), the inner region 16 comprises the circular surface internal to the ring and the adjacent annular surface up to the outer radius R₂, whilst the outer region 17 is the region external to the resonator waveguide 2 starting from R₂.

Within the present description, where referring to the radius of the resonator, reference is meant to the outer radius, R₂, unless otherwise indicated.

Preferably, resonator 2 and bus waveguides 3a, 3b are silicon-compounds based waveguides. They may be for example realized on a buffer layer formed on a silicon wafer by standard optical lithography and ion etching, or any other suitable technique.

With silicon compounds, we refer to materials comprising substantially silica glass, i.e., SiO₂, ternary compounds such as SiOₓN_{y} or Si₃N₄ and its non-stochiometric compounds. Dopants, such as Ge, B, P or Al, can be intended to be comprised in the matrix of silicon compounds, for instance in order to modify the refractive index of the material.

Preferably, resonator waveguide 2 and bus waveguides 3a, 3b have each an over-etch 40. The device 10 illustrated in FIGS. 1a and 6 can be used as an add/drop wavelength filter. The device 10 receives at the input port 4a of the first waveguide 3a, an input optical signal 11 which includes at least a signal wavelength λ₁. Preferably, the optical signal 11 carries a number of optical channels λ₁, λ₂, . . . λ_{N}, more preferably comprised between about 1530 nm and 1565 nm, which corresponds approximately to the C-band. For example, the input signal 11 can be a DWDM signal with 100 or 50 GHz of channel spacing. The resonator 2 is designed to select one of those wavelengths, for example λ₁, which is transferred to the second waveguide 3b, while all remaining channels λ₂, . . . , λ_{N} travel to the output port 4b unaffected. The particular wavelength channel λ₁ that the resonator 2 selects depend on the ring radius of the resonator and on the effective index of the mode travelling in the resonator waveguide, in formula:

$${λ}_{1} = \frac{2 π {L}_{R} {n}_{eff}}{m} \qquad ( I )$$

where m is an integer, n_{eff} the effective index of the waveguide resonator and n_{eff}L_{R} the resonator phase optical length. The interaction strength between the optical signal 11 travelling in the bus waveguide 3a and a signal in the resonator 2 (or, alternatively, between the signal in the resonator and a signal in the second waveguide 3b) depends, among other, on the material and dimensions of the two and on their relative coupling distances.

A new channel having wavelength λ₁ can also be added to the optical signal 11 by applying it to the add port 5a of the second waveguide 3b.

In the embodiment shown in FIG. 6, resonator and bus waveguides lie on the same plane and same substrate 6, which is preferably realized in a silicon compounds-based material. It is understood that other materials may be employed as known by those skilled in the art. According to the present invention, the inner region 16 of the resonator 2 is all covered by a film of an upper cladding 20 having refractive index n_{uc} which is higher than the refractive index n_{lc} of a lateral cladding 21, present in the outer region 17. In addition, in order to have guided modes along the resonator waveguide 2, the refractive index nᵣ of the resonator waveguide 2 should be larger than the refractive index n_{lc} of the lateral cladding 21, the refractive index n_{uc} of the upper cladding 20 and the refractive index n_{b} of the substrate 6. It is to be understood that layer 6 can be a substrate or a buffer layer grown on a substrate (not shown). Hereafter, layer 6 will be referred to as the substrate or the buffer layer.

The lateral cladding 21 surrounds the resonator 2 and is in contact with its outer curved edge and it then radially extends in the outer region for a finite width.

Therefore the resonator waveguide 2 is delimited in a plane parallel to the (X,Y) plane on the outer edge by the lateral cladding and on the inner edge by the upper cladding, while in the Z direction it is delimited on one side by the substrate and on the opposite side by the upper cladding.

From the above, three refractive index differences can be defined: a first index difference Δn₁=nᵣ−n_{b} between the refractive indices of the resonator waveguide 2 and the substrate 6, a second refractive index difference Δn₂=nᵣ−n_{uc} between the refractive indices of the resonator waveguide 2 and of the upper cladding 20, and a third refractive index difference Δn₃=nᵣ−n_{lc} between the refractive indices of the resonator waveguide 2 and of the lateral cladding 21.

In order to have a good confinement of the mode(s) travelling in the resonator waveguide 2, the first index difference Δn₁ should be greater than 0.3, preferably greater than 0.35, i.e. the resonator waveguide 2 should be a high index contrast waveguide with respect to the substrate 6.

For example, if the substrate 6 is SiO₂ having refractive index of 1.45, the material in which the resonant waveguide 2 is made should have at least a refractive index above 1.75.

Preferably, the third index difference Δn₃ is lower than 1.3, otherwise scattering losses may become relatively large.

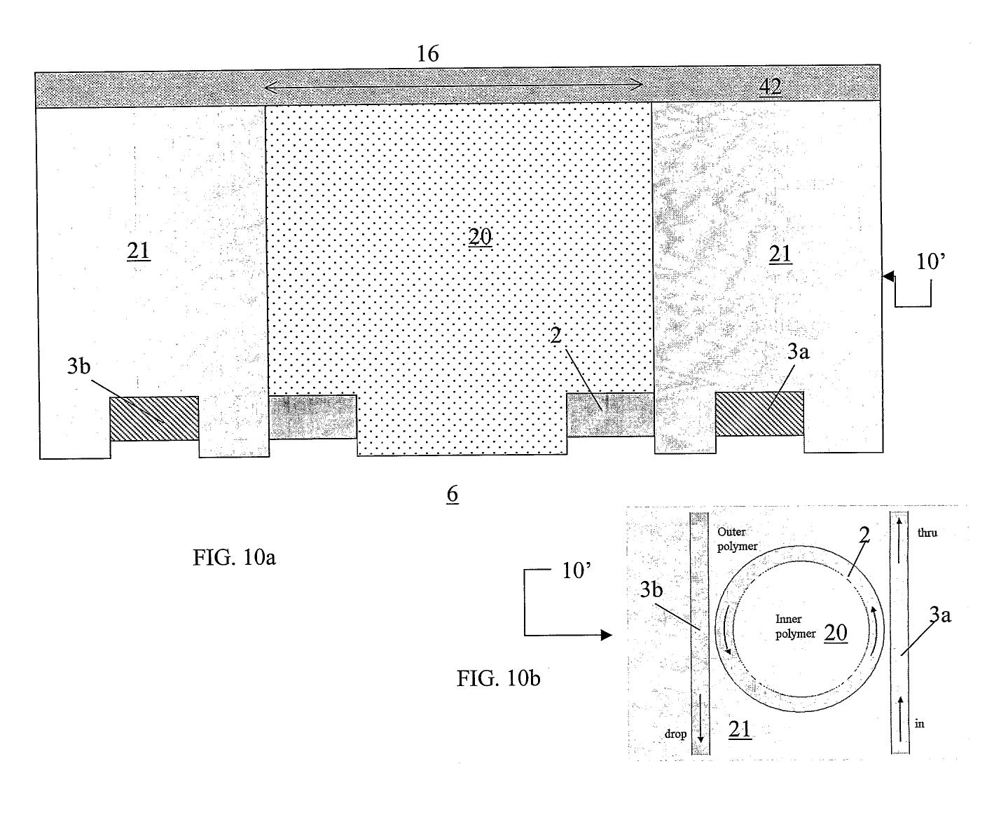

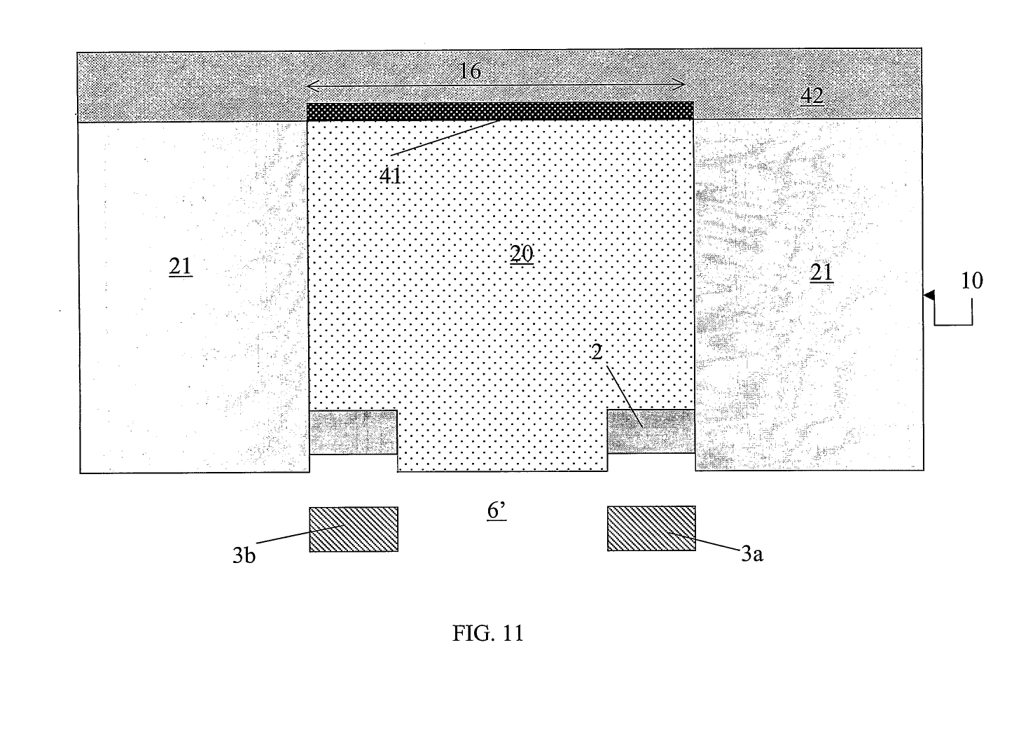

The lateral cladding 21 can be of any material as long as n_{uc}>n_{lc}. In the example of FIG. 6, the upper cladding 20 is a polymer, while the lateral cladding 21 is air. In the embodiment depicted in FIGS. 10a, 10b and in that of FIG. 11, the lateral cladding 21 can be any other deposited layer, preferably a polymer such as polytetrafluoroethylene, commercially known as Teflon™. Preferably, the upper and lateral cladding form a layer of uniform thickness above which there is air or another covering layer of a third material 42, see FIGS. 10a and 11. In case the upper cladding 20 is a liquid crystal, the covering layer 42 is preferably present, for example the covering layer is a glass layer.

The value of the thickness h (i.e. the distance between the substrate 6 and the top of the upper cladding layer) of the upper cladding 20 is not extremely relevant in the present invention; it should be preferably thick enough to embed the decaying tail of the propagating mode in the resonator waveguide 2, thus the optimal thickness depends on the wavelength of the mode and on the effective refractive index of the resonator waveguide 2. Above a certain thickness, additional thickness variations are of no relevance.

Applicants have surprisingly found that, for given refractive indices nᵣ and n_{b} of the resonator waveguide 2 and of the substrate 6, increasing the refractive index n_{uc} of the upper cladding, up to a certain maximum value given by the various resonator device characteristics (as long as it remains lower than the nᵣ of the resonant waveguide 2) lowers the propagation losses of the resonator device 10.

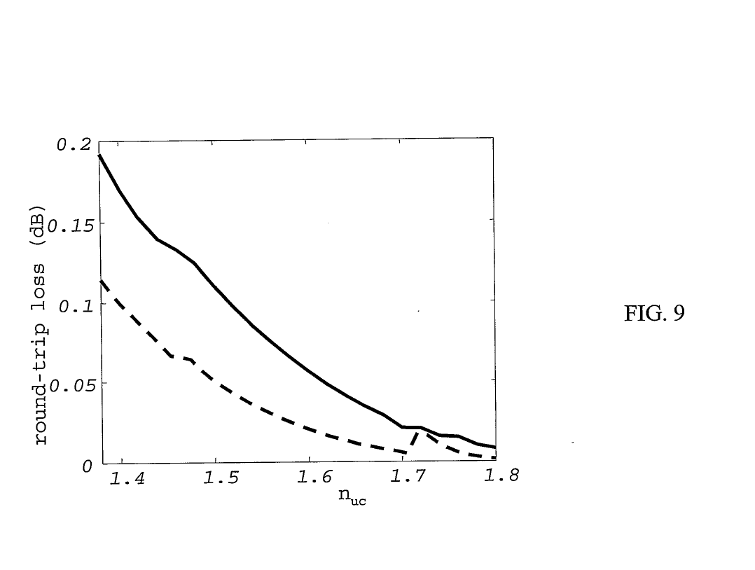

This effect is exemplified in FIG. 9, where the round-trip total losses of the resonator device 10 as a function of the upper cladding refractive index n_{uc} are shown. The studied device 10 is the device represented in FIG. 6 in which the resonator 2, lying on a SiO₂ substrate, is a ring made of Si-rich Si₃N₄ having rectangular cross-section, and the lateral cladding 21 is air. The solid line represents measurements relative to a device 10 whose resonator waveguide cross-section has dimensions 1000×300 nm with a 100 nm over-etch, while the dashed line refers to a resonator waveguide cross-section of 1200×250 nm with a 200 nm over-etch. It is clear from the graph of FIG. 9 that losses are reduced increasing the upper cladding refractive index. The following examples will show how specifically bending losses and scattering losses are affected by this upper cladding deposition.

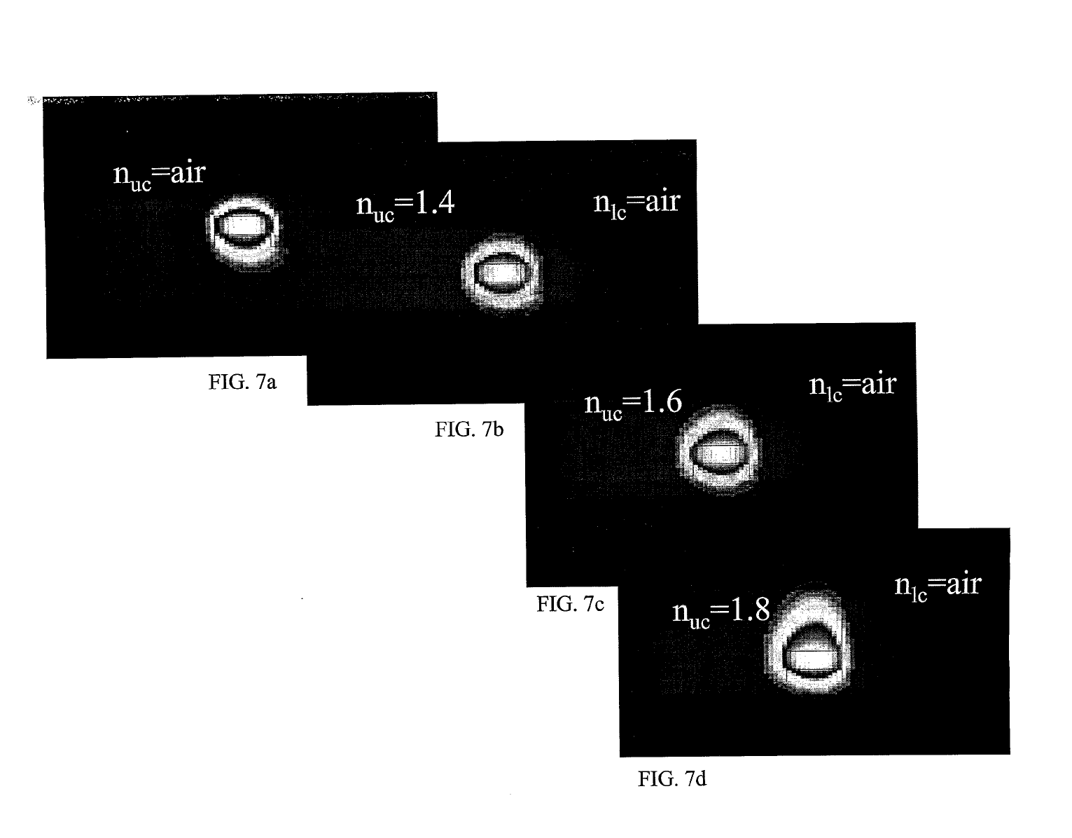

FIGS. 7a-7d show contour plots of the fundamental propagating mode in the resonator waveguide 2 for different upper cladding refractive indices n_{uc}. The first picture 7a shows the contour plots of the device 50 in which air is both the lateral 21 and the upper cladding 20.

FIGS. 7b to 7d show the same contour plot for devices 10 of the invention whose lateral cladding 21 is air, while the upper cladding has a refractive index n_{uc}=1.4, 1.6 and 1.8 respectively. From the figures, it can be derived that the mode, increasing the value of the upper cladding index, “shifts” toward the upper cladding 20, i.e. it enters more and more in the upper cladding leading to a better lateral confinement of the mode. Eventually, for this possible reason, the bending losses are reduced.

With regard to the resonant waveguide 2 dimensions, in particular regarding the dimensions of its cross-section, at least one of them should preferably be of the order of

$$\frac{λ}{{n}_{eff}} ,$$

which is the order of magnitude of the mode extension, where n_{eff} is the effective index of the resonant waveguide 2 and λ the wavelength of the propagating mode. Therefore in order for the mode to propagate also inside the upper cladding 20, one of the dimensions of the cross-section of the resonator waveguide 2 which is adjacent to the upper cladding 20 should preferably be of this order of magnitude, otherwise the mode would not significantly overlap the upper cladding.

In fact, considering as relevant dimensions the vertical dimension (in the Z-direction from substrate to the upper cladding) and the in-plane dimension (in the (X,Y) plane, from the inner edge to the outer edge separated by the ring) of the resonant waveguide cross-section, when the inner region is filled by the upper layer, the mode propagating in the resonator waveguide 2 may exceed either the vertical or the in-plane dimension in order to propagate also inside the upper cladding, so that any of the two dimensions may be of the order of the above cited ratio. If all dimensions were higher than the ratio

$$\frac{λ}{{n}_{eff}}$$

the effect shown in FIGS. 7a-7d, thus losses reduction, would be less relevant.

In addition, small cross-section dimensions allow a higher resonator-bus waveguides distance therefore decreasing the otherwise required construction accuracy and improving the resonator-waveguides coupling.

The coupling between the resonator waveguide 2 and bus waveguides 3a, 3b shown in FIG. 1a is the so-called “lateral coupling”, because the resonator waveguide 2 is side-coupled to the bus waveguides. Generally in this type of coupling the resonator and the bus waveguides are fabricated from the same materials, due to the fact that they are in the same planar layer. However the teaching of the invention is as well applicable to the “vertical coupling” configurations, an example of which is depicted in FIG. 11. In this case the resonator and the bus waveguides 2, 3a, 3b are located in different layers: the waveguides 3a, 3b are separated from the resonator 2 by the buffer layer 6′ on which the resonator is deposited; i.e. the waveguides are embedded in the layer 6′. However a reverse configuration in which the resonator is buried in the buffer layer and the waveguides lie above it can also be envisaged. Additionally, the layer in which the bus waveguides (or the resonator waveguide) are buried can be made of a different material than an additional top layer on which the resonator is deposited (i.e. a vertical stack of different layers can be fabricated). In all cases of “vertical coupling”, the materials in which resonator and bus waveguides are realized can be different.

Although in the examples the two bus waveguides 3a,3b and the resonator waveguide 2 are shown having a rectangular cross-section, waveguides with a differently shaped cross-section may be used.

### EXAMPLE 1

The resonator device 10 of FIG. 6 is studied. Resonator and bus waveguides 2,3a,3b lie on the same (X,Y) plane and the gap between the first or second waveguide 3a,3b and the resonator 2 is comprised between 100 and 150 nm. The substrate 6 is SiO₂ having refractive index nᵣ=1.45, while the resonator waveguide 2 and the bus waveguides 3a, 3b are realized in Si-rich Si₃N₄ having n_{b}=2.2. The lateral cladding 21 is air (n_{lc}=1) and the upper cladding 20 is a Sylgard™ 184 (n_{uc}=1.4005 at room temperature) film of a thickness h of 3 μm. Refractive indices are taken at a wavelength of 1550 nm. The cross-section of the bus and resonant waveguides is a 1000×300 nm rectangle with 100 nm over-etch. The resonator waveguide 2 is a ring having radius of 7 μm.

Applicants have found that the round trip total losses α of this device 10 are equal to α=0.07 dB/round trip. If the Sylgard covers the entire device, i.e. upper and lateral cladding are made of Sylgard, the losses become α=0.55 dB/round trip. If upper and lateral cladding are made of air, α=0.3 dB/round trip. This clearly shows that by positioning an upper cladding of a material different from a lateral cladding on the resonator waveguide 2, with n_{lc}<n_{uc}, micro-ring propagation losses are significantly reduced.

### EXAMPLE 2

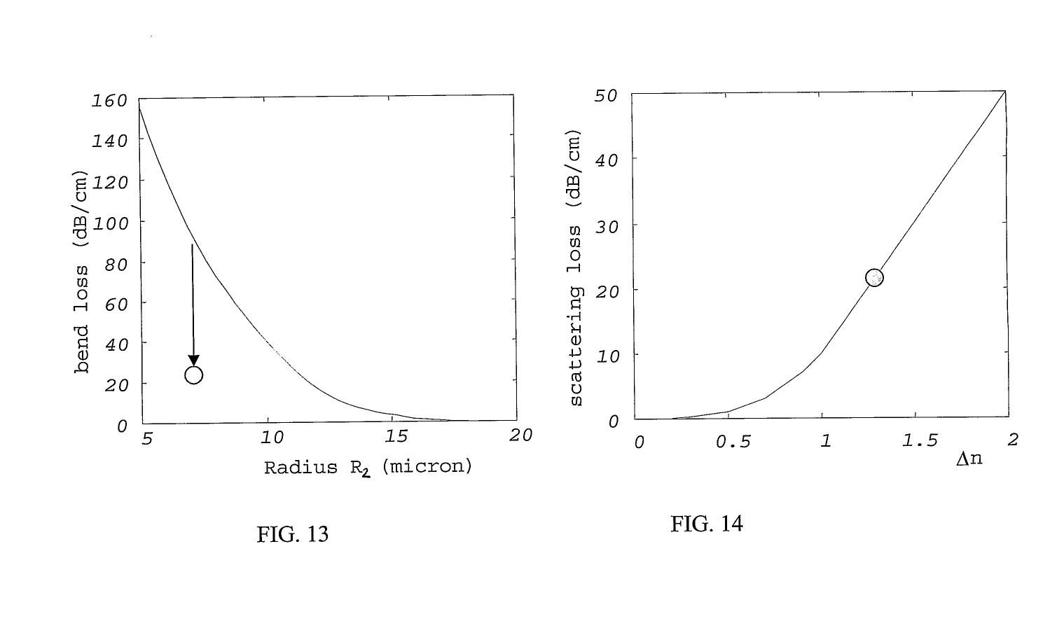

The device 10 is identical to the device of Example 1 except for the waveguides cross-section, which is in this case a rectangle of 1200×250 nm and has 200 nm over-etch. The losses are equal to α=0.1 dB/round trip or, equivalently, α=22.7 dB/cm. In FIGS. 13 and 14, the graphs of FIGS. 3 and 4 are reproduced and a circle is added in each graph showing the bending and scattering losses, respectively, of the studied device 10 of this example. From the figures, it is clear that the device 10 of the invention, with respect to the device 50 in which both upper and lateral cladding are air, but all other construction characteristics being the same, has much lower bending losses, while the scattering losses are almost unaffected.

### EXAMPLE 3

The device 10, in which bus and resonator waveguides all lie on the same plane, has the following characteristics:
substrate 6: SiO₂; nᵣ=1.45,
resonant waveguide 2, bus waveguides 3a, 3b: Si-rich Si₃N₄; n_{b}=2.2,
lateral cladding 21: air; n_{lc}=1
cross-section of all waveguides: 1000×300 nm rectangle with 100 nm over-etch

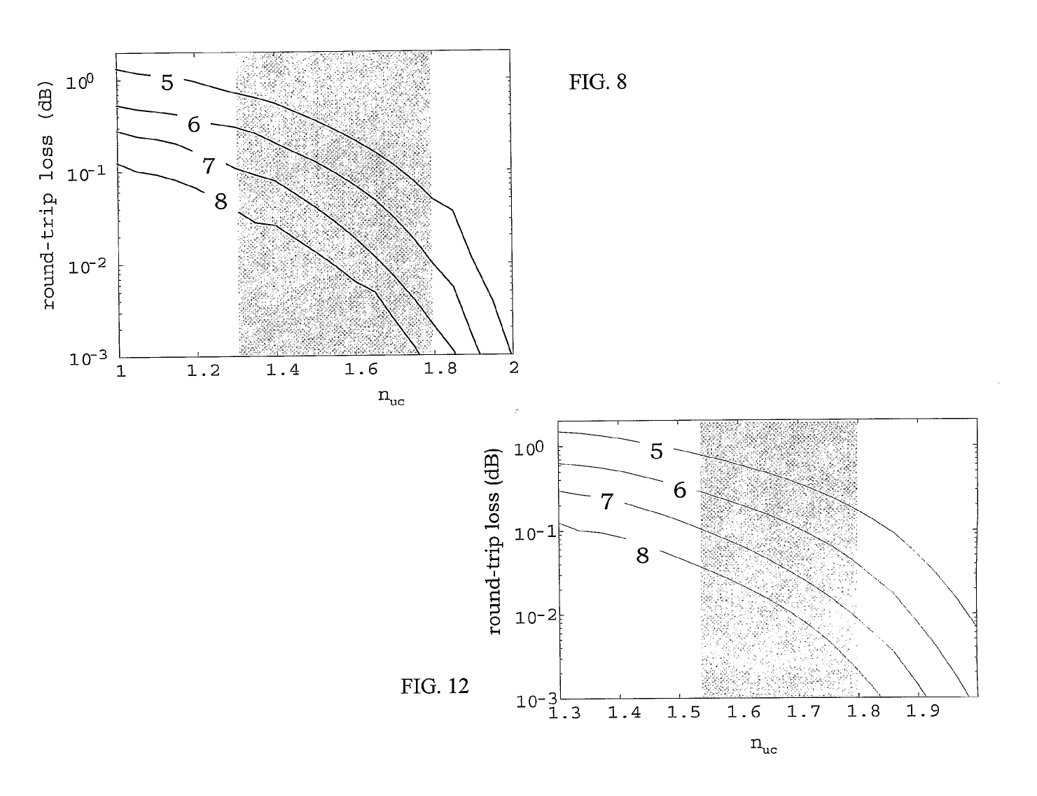

The propagation losses of this device have been computed for different resonator waveguide radii and different refractive indices of the upper cladding 20. The results are plotted in FIG. 8: the round-trip losses as a function of n_{uc} are shown for a ring radius of 5 (FSR=36 nm), 6 (FSR=30 nm), 7 (FSR=26 nm) and 8 μm (FSR=23 nm).

For the desired applications, the maximum admissible total loss is equal to 0.1 dB/round trip (equal to 22.7 dB/cm). Therefore from FIG. 8, the useful range of the refractive index of an applicable upper cladding 20 can be derived. For example, for a ring having R₂=7 μm, the useful n_{uc} range is 1.3<n_{uc}<1.8. If n_{uc}>1.8 the mode propagating in the resonator waveguide 2 delocalises, while for n_{uc}<1.3 the losses are higher than the maximum tolerated.

As expected, the useful n_{uc} range depends on the ring radius because bending losses depends on the radius (the smaller the radius, the higher the losses), therefore for a lower radius, a smaller range of indices will be efficient to reduce the losses under the desired limit of 0.1 dB/round trip.

### EXAMPLE 4

FIGS. 10a and 10b show respectively a cross sectional view and a top plan view of a device 10′ analogous to the device of Example 1, except for the provision of a Teflon™ (n_{lc}=1.3) lateral cladding 21 instead of an air cladding, and of a upper cladding 20 made of nematic LC having n_{uc}=1.6 at T=20° C. All the other parameters of the device are the same as in Example 1. The resulting losses are α=0.7 dB/cm.

As in this case in the outer region a material having n>1 is placed, Applicants have found that not only bending losses are reduced, but also scattering losses (compared to the case in which n=1), because the index contrast Δn₃ in the outer sidewalls of the resonator waveguide 2 is reduced.

In FIG. 12 the useful n_{uc} ranges for different resonator waveguide radii R₂, are calculated, in which the lateral cladding index is fixed to n_{lc}=1.3. The maximum tolerated losses are equal to 0.1 dB/round trip. For example, for a radius R=7 μm the useful n_{uc} range is 1.53<n_{uc}<1.8. The upper limit is due again to mode delocalisation. As it can be seen, the range is smaller than in Example 3, in which the lateral cladding 21 is air (n_{lc}=1). This is due to the fact that, even if a smaller index contrast Δn₃=nᵣ−n_{lc} gives smaller scattering losses, the confinement of the mode for a lower index contrast is less efficient and thus bending losses increase with respect to the case of n_{lc}=1.

### EXAMPLE 5

In the following, the useful n_{uc} ranges for resonator devices 10 having different resonator waveguide refractive index nᵣ are computed. All waveguides 2, 3a, 3b lie on the same substrate 6 which is in all examples SiO₂ having n_{b}=1.45, the lateral cladding 21 is air (n_{lc}=1), and the resonator waveguide radius is R=7 μm. The maximum tolerated losses are equal to 0.1 dB/round trip.
nᵣ=1.98 (e.g. stoichiometric Si₃N₄)
cross-section=400×1200 nm
useful n_{uc} range=1.6-1.75
nᵣ=1.98 (SiON)
cross-section=500×1300 nm
useful n_{uc} range=1.65-1.68
nᵣ=2.7
cross-section=500×1300 nm
useful n_{uc} range=1.1-2.1

From the above, the higher the first refractive index difference Δn₁₌ₙᵣ−n_{b} and/or the third refractive index difference Δn₃=nᵣ−n_{lc}, the wider useful n_{uc} range is obtained.

### EXAMPLE 6

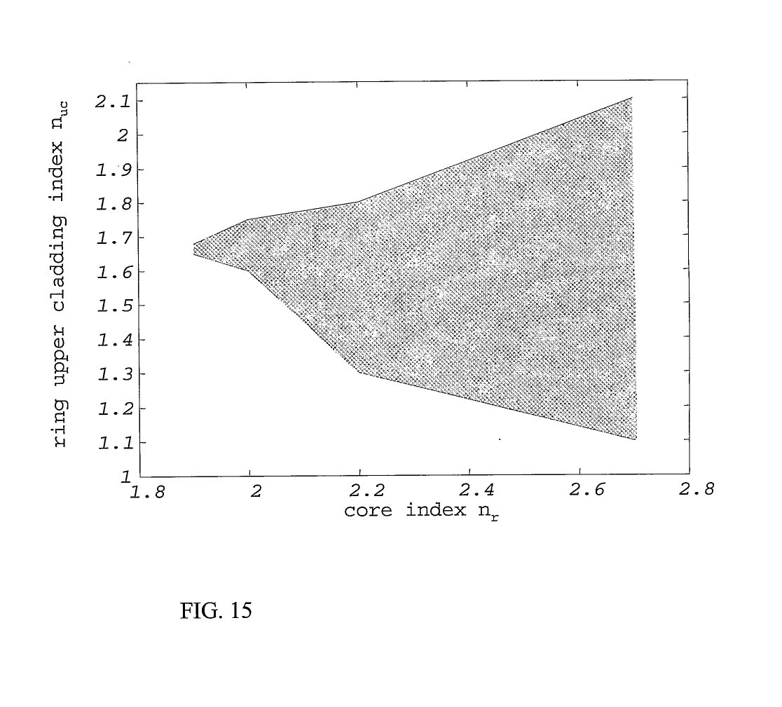

FIG. 15 summarizes the data obtained in the above examples. In particular, it is a graph of the “available” upper cladding index n_{uc} as a function of the resonator refractive index nᵣ, i.e. the ranges of n_{uc} as a function of nᵣ for which the losses of the resonator device 10 are lower than 0.1 dB/round trip. The substrate inputted in the calculations plotted in FIG. 15 is always SiO₂ having n_{b}=1.45, the lateral cladding 21 is air (n_{lc}=1), and the resonator radius is R₂=7 μm. In addition, further simulation parameters have been set so that the resonator waveguide is single-mode and that the upper cladding is such that its tunability is as close as possible to the tunability of a resonator waveguide made of Si₃N₄ (n_{uc}=2.2), i.e. of the order of Δλ=8.5 nm for Δn=0.0435. The tunability condition will be better outlined below. The dashed area included between the two solid broken lines is the region of n_{uc} for which the losses of the resonator device 10 are lower than 0.1 dB/round trip.

From the above examples, it is shown that the addition of an upper cladding, covering all the inner region in a material different from a lateral cladding, reduces the total losses of the resonant device.

The addition of an upper cladding modifies in particular the bending losses, while the addition of an upper cladding and of a lateral cladding modifies both the bending and the scattering losses. It is also clear that, the higher the refractive index of the resonator waveguide, the wider is the range of the useful refractive indices of the upper cladding which lower the total propagation losses under a given value (0.1 dB/round trip in the given examples), up to a given refractive index difference between the refractive index of the resonator waveguide and the lateral cladding above which the scattering losses are too high.

According to another aspect of the present invention, the resonator device 10 is preferably tunable, i.e. in case of applications of the resonator device 10 as a filter, the dropped wavelength in the second waveguide 3b may be changed, so that it is possible to tune the resonator device 10 from one channel to any other in the relevant spectrum. This would allow dropping any single channel with an extremely simple layout. This can possibly consist even of only one filter. It is important to note that the tuning mechanism is also preferably required to be hitless, i.e. whilst tuning from one channel to another none of the channels lying in between must be affected in any way.

Applicants have found that, in order to obtain a good tunability, the upper cladding 20 of the resonator device 10 is preferably made of a tunable material, even more preferably in such a tunable material that the whole C-band (30 nm) is covered with a single device 10.

With the term “tunable material”, we refer to a material whose refractive index can be varied by changing an external parameter, such as the temperature or the electric field. Preferably, the upper cladding 20 material of the present invention is taken from the category of materials classified as polymers, which have an index of refraction n_{uc} that varies with temperature T, n_{uc}(T). In particular their preferred thermo-optic coefficient

$$\vert \frac{ⅆ n}{ⅆ T} \vert$$

is not smaller than 1×10⁻⁴/° C., which means that their refractive indices can vary significantly in a relatively small temperature range. This corresponds to index variations Δn_{uc}, for a ΔT of 100-200° C., not smaller than about 0.01.

Indeed, calling

$$C = \vert \frac{ⅆ n}{ⅆ T} \vert ,$$

the tuning range with a given maximum temperature variation ΔT is given by

$$\frac{Δλ}{λ} = \frac{Δ {n}_{uc}}{{n}_{uc}} = C \frac{Δ T}{{n}_{uc0}} \qquad ( II )$$

where n_{uc0} is the material refractive index at the initial temperature T₀.

Preferred polymers are DeSolite™ 3471-1-129 produced by DSM or Sylgard™ 184 produced by Dow Corning. A list of possible additional polymers with their actual C and refractive indices values as measured by the Applicants is given in Table I. However any transparent polymer satisfying the above written requirements is suitable for the realization of the upper cladding 20.

It is to be noted that the suitable polymer for the upper cladding 20 should be selected so that its refractive index n_{uc}(T) remains smaller than that of the resonator waveguide 2 and bus waveguides 3a,3b in the entire temperature range of interest for the functioning and tunability of the resonator device 10.

Applicants note that although also silica has a refractive index that varies with temperature, the order of magnitude of its thermo-optic coefficient is sensibly smaller than those of polymers, namely at least a factor of 10, the thermo-optic coefficient of silica being of about 10⁻⁵/° C. Considering its refractive index of 1.45 (for undoped silica), the value of

$$\frac{Δ n}{n}$$

for a variation of 200° C. is only of the order of 10⁻³. Therefore, within this context, silica is considered a “non-tunable” material. With the term “tunable material”, we refer herein to a material in which

$$\frac{Δ n}{n} \geq {10}^{- 2}$$

for a reasonable variation of the external parameter. It is to be noted than in this context, non-tunable materials (i.e. materials in which

$$\frac{Δ n}{n} < {10}^{- 2} )$$

comprise also materials having relatively high thermo-optic or electro-optic coefficient, but low

$$\frac{Δ n}{n} ,$$

i.e., lower than 10⁻² for a temperature variation of 100° C. or for an electric field variation of 1 V/μm. An example of non-tunable material with relatively high thermo-optic coefficient is GaAs, where dn/dT=2.5×10⁻⁴/° C. and n=3.4 (at room temperature). A variation in temperature of 100° C. gives a variation in the refractive index Δn of 0.025, but a

$$\frac{Δ n}{n}$$

of about 7×10⁻³.

TABLE I

| | n (@ 1550 nm) | dn/dT (/° C.) |
|---|---|---|
| Sylgard 184 (Dow Corning) | 1.4 | −2.9E−4 |
| Tego Rad 2500 (TEGO) | 1.419 | −2.95E−4 |
| Tego Rad 2100 (TEGO) | 1.4419 | −2.4E−4 |
| OE-4100 (Dow Corning) | 1.46 | −3.3E−4 |
| Desolite ™ 3471-1-129 | 1.48 | −2.5E−4 |

The polymer forming the upper cladding 20 may be deposited over the resonator 2 by spin coating as the last fabrication step of the resonator device construction and then it is etched in the proper shape so as to cover only the inner region.

However the invention is not limited to thermo-optic materials, but it also covers materials having electro-optical properties as long as their refractive index can be varied in a relatively wide range, as liquid crystals, for a reasonable variation of the applied electric field. Preferably, the liquid crystal has Δn=0.1 for variations of electric field of 1 to 5 V/μm.

In case a liquid crystal is employed as the upper cladding 20 of the resonator waveguide, a lateral cladding 21 different from air is preferred in order to laterally confine the LC material. This liquid crystal material is indeed liquid and therefore without a lateral cladding material, such as for example Teflon™, it would not remain contained over the resonator waveguide 2. If this liquid crystal (or any generic upper cladding material) is not confined only over the inner region then the tuning range will be only fractionally higher at the expense of much higher losses.

In another embodiment of the present invention (not shown), two different tunable materials are used as upper 20 and lateral cladding 21 so that the resulting overall tunability of the device 10 is enhanced.

Additionally, also the substrate 6 can be realized in a tunable material.

In order to tune the upper cladding, an electrode 41 (see FIG. 11) may be placed on top of the upper cladding 20. The thickness h of the cladding 20 is in this case preferably higher than a certain value for which the presence of the electrode 41 interferes with the proper functioning of the resonator device 10.

With reference to FIG. 10a, when a liquid crystal upper cladding is realized, two electrodes are placed (not shown), preferably on top of the covering layer 42.

In case of a tunable resonator device 10, the fact that at least a dimensions of the resonator waveguide cross-section is smaller than the ratio

$$\frac{λ}{{n}_{eff}}$$

is important because if the mode in the resonator waveguide 2 did not propagate for a portion also inside the upper cladding 20, a very low tunability would be achieved because shifting the refractive index of the upper cladding would not make any significant difference in the mode propagation.

### EXAMPLE 7

The tunability of the device 10 of example 1, depicted in FIG. 6, is tested. As previously said, the upper cladding 20 is made of Sylgard™ 184, which is a tunable polymer. This polymer has a high thermo-optic coefficient equal to −2.9·10⁻⁴/° C. and the applied variation in temperature is of 70° C. Using eq. (II) and by numerical simulations, Applicants have found that by changing the temperature of said amount, the effective index of the resonator waveguide 2 is changed and the dropped wavelength of the filter is shifted by Δλ=5.5 nm. If the Sylgard™ 184 covers the whole inner and outer region uniformly then the shifts is Δλ=6.2 nm, which is an 11% variation, but, as seen in Example 1, a much more significant variation in the round trip losses is also obtained.

In case Teflon™ is the lateral cladding 21, as depicted in FIG. 10a, instead of air, the tuning range remains substantially unchanged.

### EXAMPLE 8

The only difference between the device studied in this example and the device 10 of Examples 1, is that in the present case the resonator waveguide 2 has a cross section of 1200×250 nm and a 200 nm over-etch. Applicants have found that for a temperature variation of ΔT=150° C. the resulting Δn_{uc}=0.0435, which implies Δλ=8.5 nm. The losses are α=0.1 dB/round trip.

### EXAMPLE 9

In this Example, the device 10′ depicted in FIGS. 10a and 10b is tuned. In particular the lateral cladding 21 is Teflon™ and the upper cladding 20 is a nematic liquid crystal. For a voltage variation of ΔE=1.5 V/μm the resulting Δn_{uc}=0.1, from which Δλ=8.5 nm. The resulting losses are α=0.07 dB/round trip.

From the above examples, it is clear that the resonator device 10, 10′ of the present invention has a wide tuning range and at the same time is rather easy and relatively cheap to fabricate: fabrication is carried out using the desired materials optimised for the desired resonator properties and the tuneable layer is applied only at the last stage as an upper cladding, it is then etched so that only the inner region of the resonator device 10 is covered. In this way, the tunable material is integrated with the standard and well tested materials such as silicon compounds, without imposing any limitations in the other fabrication step and having at the same time a large tunability range guaranteed by this polymer/liquid crystal upper cladding 20. In addition, a large tuning is obtained without affecting the resonator waveguide 2, which is the core region in which the mode propagates. In this way the resonator 2 can be made of any material.

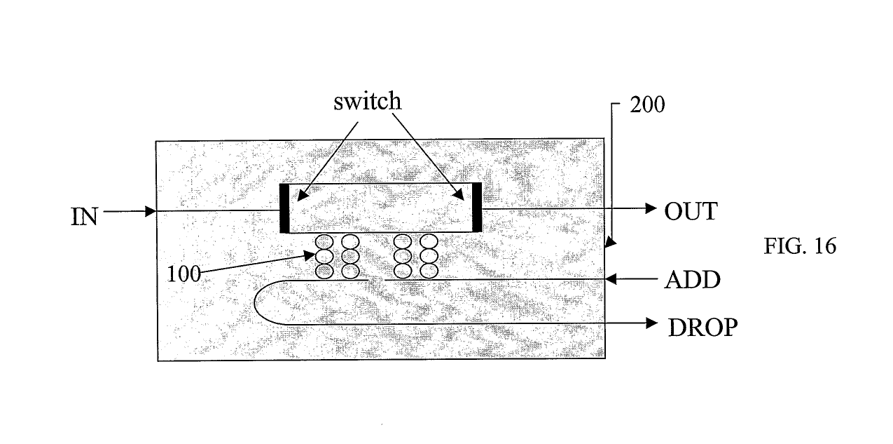

A possible application of the resonator device 2 is given in FIG. 16, in which a Mach-Zehnder switch 200 comprises four resonator devices 100 of the third order, as in FIG. 1b. In particular each single resonator 2 of the device 100 is covered by a layer of liquid crystal as upper cladding and the lateral cladding is Teflon (each single resonator is equal to the one of example 1).

Each ring has a radius of 7 μm and the total covered bandwidth is equal to 26 nm.

1-25. (canceled)

26. A low loss micro-ring resonator device comprising
a closed-loop resonator waveguide having a first refractive index, said resonator waveguide defining an inner and an outer region by an outer curved edge of said waveguide, said resonator waveguide being arranged on a substrate having a second refractive index, the refractive index difference between said first refractive index and said second refractive index being greater than 0.3;
an upper cladding covering said inner region of said resonator waveguide having a third refractive index; and
a lateral cladding in contact with said outer curved edge and extending in said outer region, said lateral cladding having a fourth refractive index, said fourth refractive index being lower than said third refractive index.

27. The resonator device according to claim 26, wherein said upper cladding comprises a tunable material.

28. The resonator device according to claim 26, wherein at least one of the dimensions of the cross-section of said closed-loop resonator waveguide is of the order of
$$\frac{λ}{{n}_{eff}} ,$$
wherein n_{eff} is the effective index of the resonator waveguide and λ is the wavelength of a propagating mode in the resonator waveguide.

29. The resonator device according to claim 26, comprising a first waveguide being in substantially close proximity to said resonator waveguide in a predetermined region to provide coupling there-between.

30. The resonator device according to claim 26, wherein said resonator waveguide is a single mode waveguide.

31. The resonator device according to claim 26, wherein said resonator waveguide comprises silicon compound materials.

32. The resonator device according to claim 26, wherein said substrate comprises silicon compound materials.

33. The resonator device according to claim 29, comprising a second waveguide, said first waveguide being adapted for carrying an input signal having at least a channel of a given wavelength, and said resonator waveguide being operable so that said given wavelength is transferred to said second waveguide.

34. The resonator device according to claim 33, wherein said input signal comprises a given number of optical channels having wavelengths of about 1530 to about 1565 nm.

35. The resonator device according to claim 26, wherein the radius of the closed-loop resonator waveguide is 5 to 10 μm.

36. The resonator device according to claim 35, wherein the radius of the closed-loop resonator waveguide is not larger than 8 μm.

37. The resonator device according to claim 26, wherein the closed-loop resonator waveguide is a ring.

38. The resonator device according to claim 33, wherein said resonator waveguide and said waveguides are arranged in a lateral coupling configuration.

39. The resonator device according to claim 33, wherein said resonator waveguide and said waveguides are arranged in a vertical coupling configuration.

40. The resonator device according to claim 27, wherein the third refractive index of said tunable material can be varied upon variation of an external parameter.

41. The resonator device according to claim 27, wherein the tunable An material is variable with temperature and said tunable material has a ratio
$$\vert \frac{Δ n}{n} \vert$$
between the variation Δn of the third refractive index and the refractive index of said tunable material not smaller than 10⁻² for a temperature variation not larger than 100° C.

42. The resonator device according to claim 27, wherein the tunable material is variable with an electric field and said tunable material has a ratio
$$\vert \frac{Δ n}{n} \vert$$
between the variation Δn of the refractive index and the refractive index of said tunable material not smaller than 10⁻² for an electric field variation not larger than 5 V/μm.

43. The resonator device according to claim 27, wherein the refractive index of said tunable material is variable with temperature and said tunable material has a thermo-optic coefficient
$$\vert \frac{ⅆ n}{ⅆ T} \vert$$
greater than or equal to 10⁻⁴/° C.

44. The resonator device according to claim 27, wherein said tunable material variable with temperature is a polymer.

45. The resonator device according to claim 27, wherein said tunable material is a liquid crystal.

46. The resonator device according to claim 26, wherein said lateral cladding comprises a tunable material.

47. An add/drop optical device comprising one of more of the resonator devices according to claim 26.

48. A method to reduce the propagation losses of a resonator device, comprising the steps of:
realizing a closed loop resonator waveguide having a first refractive index on a substrate having a second refractive index, the refractive index difference between said first refractive index and said second refractive index being greater than 0.3, said resonator waveguide defining an inner and an outer region by an outer curved edge of said waveguide; and
adding an upper layer in said inner region having a third refractive index greater than a fourth refractive index of a lateral cladding in contact with said outer curved edge of said resonator waveguide and extending in said outer region.

49. The method according to claim 48, comprising the step of forming said lateral cladding by depositing a layer of material on said outer region.

50. The method according to claim 48, wherein said upper layer is formed from a tunable material.
